(19) United States
(12) Patent Application Publication
(10) Pub. No.: US 2012/0308465 A1
(43) Pub. Date: Dec. 6, 2012

(54) METHOD FOR PRODUCING TRICHLOROSILANE BY THERMAL HYDRATION OF TETRACHLOROSILANE

(75) Inventors: Nuria Garcia-Alonso, Muenchen (DE); Christoph Rüedinger, Starnberg (DE); Hans-Jürgen Eberle, Muenchen (DE)

(73) Assignee: WACKER CHEMIE AG, Munich (DE)

(21) Appl. No.: 13/585,235

(22) Filed: Aug. 14, 2012

Related U.S. Application Data
(63) Continuation of application No. 11/815,353, filed on Aug. 2, 2007, now abandoned.

(30) Foreign Application Priority Data
Feb. 3, 2005 (DE) 10 2005 005 044.1

(51) Int. Cl. C01B 33/107

(52) U.S. Cl. 423/342

(57) ABSTRACT

Efficient production of trichorosilane from tetrachlorosilane and hydrogen is effected by reaction at high temperatures over short residence times followed by rapidly cooling the product mixture in a heat exchanger, recovered heat being employed to heat the reactant gases, which are then fed to the reactor in a heated state.

This application is a continuation of U.S. application Ser. No. 11/815,353 (pending), filed Aug. 2, 2007, which is the U.S. national phase of PCT Appln. No. PCT/EP2006/000692, filed Jan. 26, 2006 which claims priority to German application DE 10 2005 005 044.1, filed Feb. 3, 2005, the disclosure(s) of which are incorporated in their entirety by reference herein.

### BACKGROUND OF THE INVENTION

1. Field of the Invention

The invention relates to a process for preparing trichlorosilane by means of thermal hydrogenation of silicon tetrachloride.

2. Description fo the Related Art

In the preparation of polycrystalline silicon by reacting trichlorosilane (sitri) with hydrogen, large amounts of tetrachlorosilane (tetra) are obtained. The tetrachlorosilane can be converted back to sitri and hydrogen chloride by the silane conversion, a catalytic or thermal dehydrohalogenation reaction of tetrachlorosilane with hydrogen. In industry, two process variants are known for this purpose:

In the low-temperature process, a partial hydrogenation is effected in the presence of silicon and catalyst (for example metallic chlorides) at temperatures in the range from 400° C. to 700° C.; see, for example, U.S. Pat. No. 2,595,620 A, U.S. Pat. No. 2,657,114 A (Union Carbide and Carbon Corporation/Wagner 1952) or U.S. Pat. No. 294,398 (Compagnie de Produits Chimiques et electrometallurgiques/Pauls 1956).

Since the presence of catalysts, for example copper, can disrupt the purity of the sitri and of the silicon prepared therefrom, a second process, known as the high-temperature process, has been developed. In this process, the tetrachlorosilane and hydrogen reactants are reacted at relatively high temperatures without catalyst. The tetrachlorosilane conversion is an endothermic process where the formation of the products is equilibrium-limited. In order to obtain significant sitri generation at all, very high temperatures have to be employed in the reactor (>900° C.). For instance, U.S. Pat. No. 3,933,985 (Motorola INC/Rodgers 1976) describes the reaction of tetrachlorosilane with hydrogen to give trichlorosilane at temperatures in the range from 900° C. to 1200° C. and with a molar H₂:SiCl₄ ratio of from 1:1 to 3:1. Yields of 12-13% are described.

The patent U.S. Pat. No. 4,127,334 (Degussa/Weigert 1980) reports an optimized process for converting tetrachlorosilane to trichlorosilane by means of the hydrogenation of tetrachlorosilane with hydrogen within a temperature range from 900° C. to 1200° C. A high molar H₂:SiCl₄ ratio (up to 50:1) and liquid quenching of the hot product gas below 300° C. achieves significantly higher trichlorosilane yields (up to approx. 35% at H₂:tetra 5:1). A disadvantage of this process is the significantly higher hydrogen content in the reaction gas and the employment of a quench by means of a liquid, both of which greatly increase the energy demands of the process and hence greatly increase the costs.

JP 60081010 (Denki Kagaku Kogyo K.K./1985) likewise describes a quench process (at relatively low H2:tetra ratios) for increasing the trichlorosilane content in the product gas. The temperatures in the reactor are from 1200° C. to 1400° C., and the residence time in the reactor is 1-30 seconds; the reaction mixture is cooled rapidly down to less than 600° C. within one second. (SiCl₄ liquid quench, molar H₂:tetra ratio=2, sitri yield at 1250° C.:27%.) However, in this quench process too, it is disadvantageous that the energy of the reaction gas is for the most part lost, which has a very adverse effect on the economic viability of the processes.

### SUMMARY OF THE INVENTION

It is an object of the present invention to provide a process for preparing trichlorosilane by means of thermal hydrogenation of a reactant gas comprising silicon tetrachloride, which enables a high trichlorosilane yield with increased economic viability compared to the prior art. These and other objects are achieved by the high temperature reaction of hydrogen and tetrachlorosilane, rapidly cooling the product mixture in a heat exchanger at a specific rate, and recovering heat by heating reactant gases.

### BRIEF DESCRIPTION OF THE DRAWINGS

FIGS. 1a-1f illustrate embodiments of heat exchangers useful in the process of the invention;

FIG. 2 illustrates one embodiment of the process of the invention;

FIG. 3 illustrates the relationship between reactant gas temperature and product gas temperature in accordance with certain embodiments of the invention.

### DETAILED DESCRIPTION OF THE PREFERRED EMBODIMENT(S)

The process thus comprises reacting a silicon tetrachloride-containing reactant gas and a hydrogen-containing reactant gas a temperature of from 700 to 1500° C. to form a trichlorosilane-containing product mixture, characterized in that the product mixture is cooled by means of a heat exchanger, the product mixture being cooled to a temperature T_{Cooling} over a residence time of the reaction gases in the heat exchanger T [ms], where

$$τ \leq A \cdot e \frac{- B \cdot {T}_{Cooling}}{1000} \qquad ( Equation 1 )$$

where A=4000, 6≦B≦50, and 100° C. ≦T_{Cooling}≦900° C., and the energy of the product gas removed via the heat exchanger being used to heat the reactant gases.

2 5 By means of the process according to the invention, the production costs for trichlorosilane are reduced by virtue of the better energetic integration, the increase in the space-time yield and the improvement in the degree of conversion of the tetrachlorosilane conversion. The use of a heat exchanger which consists of a material inert under the reaction conditions and whose construction enables a very short residence time of the product gas substantially prevents a back-reaction, and the heating of the reactant gases greatly improves the energy balance.

Preference is given to reacting silicon tetrachloride with hydrogen at a temperature of from 900° C. to 1100° C.

Preferably, 7≦B≦30. For the temperature of the cooled product mixture, preferably: 200° C.≦T_{cooling}≦800° C. More preferably, 280° C.≦T_{cooling}≦700° C.

The residence time of the reaction gas in the reactor is more preferably less than 0.5 s.

Surprisingly, it has been found in the context of the present invention that, at temperatures of ≧1000° C., the establishment of the appropriate equilibrium-limited sitri concentration is complete as early as within 0.5 second. It has also been found that, surprisingly, especially up to 700° C., a significantly more rapid cooling rate than assumed to date is advantageous in order to obtain the established equilibrium (for example 1100° C.: sitri content approx. 21% by weight). The cooling operation to 700° C. should therefore preferably be complete within less than 50 ms.

A heat exchanger for cooling the product gas and for the simultaneous heating of the reactant gases which is suitable for the process according to the invention consists preferably of a material selected from the group of silicon carbide, silicon nitride, quartz glass, graphite, SiC-coated graphite and a combination of these materials. The heat exchanger more preferably consists of silicon carbide.

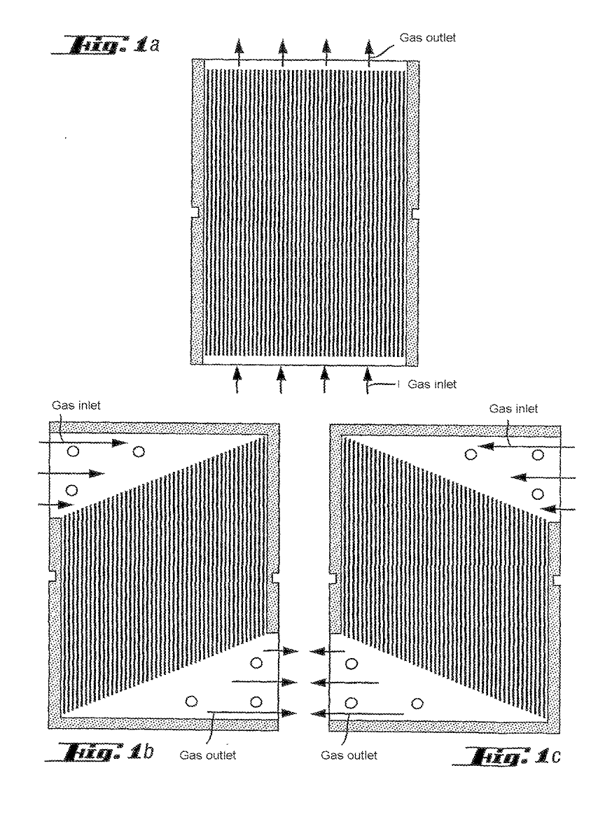

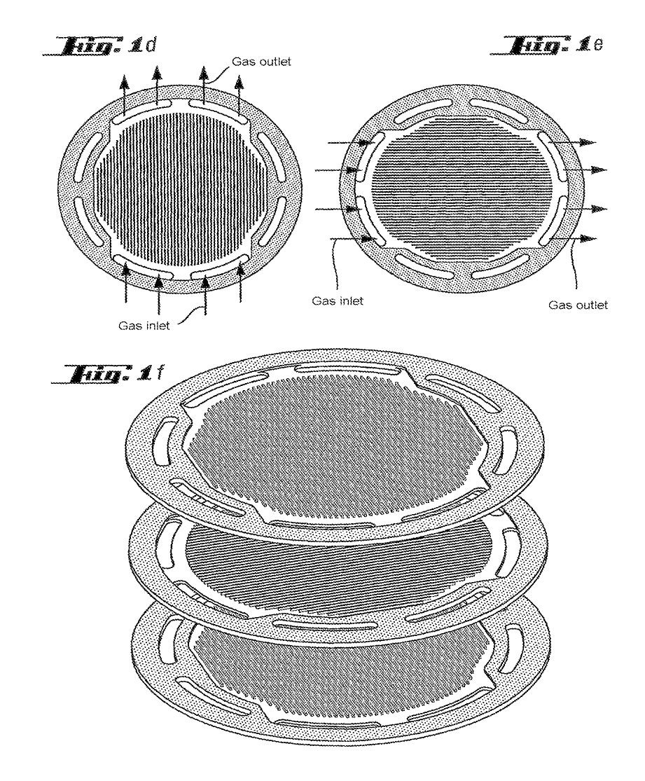

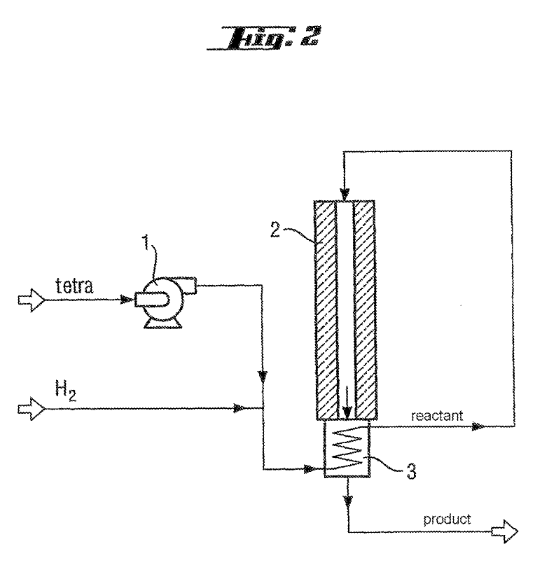

The heat exchanger is preferably a plate heat exchanger or a tube bundle heat exchanger, the plates being arranged with channels or capillaries in stacks (FIGS. 1a-1f).

The arrangement of the plates is preferably configured such that only product gas flows in one part of the capillaries or channels and only reactant gas flows in the other part. Mixing of the gas streams must be prevented. The different gas streams can be conducted in countercurrent or else in cocurrent. The construction of the heat exchanger is selected such that, with the cooling of the product gas, the energy released serves simultaneously to heat the reactant gas. The capillaries may also be arranged in the form of a tube bundle heat exchanger. In this case, a gas stream flows through the tubes (capillaries), while the other gas stream flows around the tubes.

Irrespective of which type of heat exchanger is selected, particular preference is given to heat exchangers which fulfill at least one, preferably more than one, of the following construction features:

The hydraulic diameter (Dh) of the channels or of the capillaries, defined as 4×cross-sectional area/circumference, is less than 5 mm, preferably less than 3 mm. The ratio of exchange area to volume is >400 m⁻¹. The heat transfer coefficient is preferably greater than 300 watts/m²K.

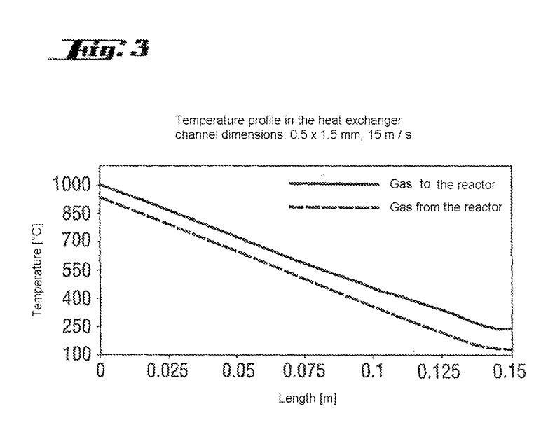

The heat exchanger 3 can be arranged immediately downstream of the reaction zone (FIG. 2), but it can also be connected to the reactor 2 via a heated line which is preferably kept at reaction temperature. Once the reaction mixture (product gas) has been cooled to below 700° C. within 50 ms, the reaction gas can be passed on into a customary cooler.

FIGS. 1a-1f show, by way of example, the design of two embodiments of heat exchanger internals suitable for the process according to the invention.

FIG. 2 shows a schematic of the setup of an apparatus for performing the process according to the invention (1 silane pump, 2 reactor, 3 heat exchanger).

FIG. 3 shows the temperature profile in the heat exchanger according to example 5.

The invention will be illustrated specifically hereinafter with reference to examples and comparative examples.

The experiments were performed in a quartz glass reactor. The reactor is constructed such that it is divided into different zones, and these zones can be heated to different temperatures. A heat exchanger is attached directly to the last heating zone. The gas residence time in the individual zones can be varied within a wide range by the incorporation of appropriate displacers. The gas mixture leaving the reactor and also the heat exchanger can be analyzed for its composition by means of a sampling point either online or offline (gas chromatography).

### EXAMPLE 1

In a quartz glass reactor, a mixture of 170 g/h of tetrachlorosilane and 45 1 (STP)/h (1 (STP): standard liters) of hydrogen was fed in. In the reaction zone, there was a temperature of 1100° C. and an elevated pressure of 10.5 kPa. The residence time of the reaction gas in the reaction zone was 0.30 s. The product mixture leaving the reaction zone (tetra/sitri/H₂/HCl mixture) was cooled to 700° C. within 25 ms (r). This residence time is within the inventive range defined by equation 1 (T_{Ex.1} 700° C., B_{Ex.1} is calculated to be 7.2). The maximum permissible residence time in accordance with the invention in the heat exchanger under these conditions (700° C., B=6) would be τ=60 ms. (Dh of the heat exchanger=2 mm.) The product mixture exhibited, after condensation, the following composition [% by weight]:

| | |
|---|---|
| tetrachlorosilane | 79.50% |
| trichlorosilane | 20.05% |
| dichlorosilane | 0.45% |

This example shows that the sitri yield remains high when cooling is effected to 700° C. within 25 ms.

### EXAMPLE 2 (COMPARATIVE EXAMPLE 1)

Analogously to example 1, a mixture of 103 g/h of tetrachlorosilane and 23 1 (STP)/h of hydrogen is fed into the reactor. In the reaction zone, there was a temperature of 1100° C. and an elevated pressure of 3.0 kPa. The residence time in the reaction zone was 0.40 s. In the subsequent cooling step, the product mixture is cooled to 700° C. within 186 ms (T_{Ex.2} 700° C., B_{Ex.2} is calculated to be 4.3 and is thus outside the range permissible according to equation 1). (Dh of the heat exchanger=15 mm). The product mixture exhibited, after condensation, the following composition [% by weight]:

| | |
|---|---|
| tetrachlorosilane | 85.2% |
| trichlorosilane | 14.75% |
| dichlorosilane | 0.1% |

This example shows that the sitri yield is reduced in the event of noninventive cooling.

### EXAMPLE 3

Analogously to Ex.1, 81.7 g/h of tetrachlorosilane and 22.8 1 (STP)/h of hydrogen were fed into the reactor. The temperature in the reaction zone was 1100° C.; the elevated pressure was 3.0 kPa. The residence time of the gas in the reaction zone was 0.90 s. The product mixture was cooled to 600° C. within 30 ms. The maximum permissible residence time in accordance with the invention in the heat exchanger under these conditions (600° C., B=6) would be T=109 ms. (Dh of the heat exchanger=2 mm).

The product mixture exhibited, after condensation, the following composition [% by weight]:

| | |
|---|---|
| tetrachlorosilane | 79.3% |
| trichlorosilane | 20.6% |
| dichlorosilane | 0.10% |

This example shows that a longer reaction time brings no further advantages.

### EXAMPLE 4

Analogously to Ex.1, 737 g/h of tetrachlorosilane and 185 1 (STP)/h of hydrogen were fed into the reactor. The temperature in the reaction zone was 1100° C.; the elevated pressure was 28.5 kPa. The residence time of the gas in the reaction zone was 0.30 s. The product mixture was cooled to 700° C. within 60 ms (T_{Ex.4} 700° C., B_{Ex.4} is calculated to be 6 and thus corresponds to the limiting value permissible in accordance with the invention). (Dh of the heat exchanger=5 mm). The product mixture exhibited, after condensation, the following composition [% by weight]:

| | |
|---|---|
| tetrachlorosilane | 81.8% |
| trichlorosilane | 19.1% |
| dichlorosilane | 0.10% |

### EXAMPLE 5

### Design of the Heat Exchanger:

The heat transfer of a countercurrent heat exchanger having a hydraulic diameter of approx. 1 mm and a ratio of exchange area/volume of 5300 m⁻¹ was calculated for a gas stream with a composition as in examples 1 to 4. For a gas velocity=15 m/s and pressure=500 kPa, a K value=550, a ΔT=90° C. and an energy recovery=93% within 15 ms are calculated (FIG. 3).

1. A process for producing trichlorosilane by reaction of tetrachlorosilane with hydrogen, comprising reacting a tetrachlorosilane-containing reactant gas and a hydrogen-containing reactant gas in a reactor at a reaction temperature of from 700° C. to 1500° C. to form a trichlorosilane-containing product gas mixture, and cooling the product mixture by means of a heat exchanger constructed of a material selected from the group consisting of silicon carbide, silicon nitride, quartz glass, graphite, silicon carbide coated graphite and combinations thereof, wherein passages in the. heat exchanger have a hydraulic diameter <5 mm, the heat exchanger has a ratio of heat exchange surface to volume of >400 m⁻¹ and a heat transfer coefficient of >300 watts /m²K, and cooling the product gas mixture to a temperature T_{Cooling} over a heat exchanger residence time of the product gas mixture in the heat exchanger τ [ms], where
$$τ \leq A \cdot e \frac{- B \cdot {T}_{Cooling}}{1000} \qquad ( Equation 1 )$$
where A=4000, 6≦B<50, and 100° C.≦T_{Cooling}≦900° C., wherein the product gas mixture is cooled by reactant gases in the heat exchanger to a temperature lower than the reaction temperature and at most 700° C. in less than 50 ms, and the reactant gases are heated thereby.

2. The process of claim 1, wherein 7≦B≦30 and 200° C.≦T_{Cooling}≦800° C.

3. The process of claim 1, wherein 7≦B≦30 and 280° C.≦T_{Cooling}≦800° C.

4. The process of claim 1, wherein the residence time of the reactant gases in the reactor is <0.5 s.

5. The process of claim 2, wherein the residence time of the reactant gases in the reactor is <0.5 s.

6. The process of claim 3, wherein the residence time of the reactant gases in the reactor is <0.5 s.

7. The process of claim 1, wherein the heat exchanger comprises silicon carbide.

8. The process of claim 1, wherein the product gas mixture is cooled to 700° C. within 25 ms.

9. The process of claim 1, wherein the product gas mixture is cooled to 600° C. within 30 ms.

10. The process of claim 1, wherein the hydraulic diameter of the heat exchanger passages is less than 3 mm.

11. The process of claim 1, wherein a product mixture exiting from the heat exchanger is further cooled.

12. The process of claim 1, wherein the heat exchanger is a plate-type heat exchanger of silicon carbide.

13. The process of claim 1, wherein the heat exchanger prohibits mixing of the product gas mixture with the reactant gases.

14. The process of claim 1, wherein the heat exchanger is positioned outside of the reactor.

15. The process of claim 14, wherein the product gas mixture exiting the reactor is fed to the heat exchanger through a heated line, the heated line being heated such that the product gas mixture has substantially the same temperature as it had upon exiting the reactor when the product gas mixture enters the heat exchanger.
